(19) United States
(12) Patent Application Publication
(10) Pub. No.: US 2026/0319666 A1
(43) Pub. Date: Oct. 15, 2026

(54) APPARATUSES, METHODS OF OPERATING STORAGE APPARATUSES, AND ELECTRONIC SYSTEMS

(71) Applicant: YANGTZE MEMORY TECHNOLOGIES CO., LTD., Wuhan (CN)

(72) Inventor: Zhenran LU, Wuhan (CN)

(21) Appl. No.: 19/288,883

(22) Filed: Aug. 1, 2025

(30) Foreign Application Priority Data
Apr. 10, 2025 (CN) 2025104500781

(51) Int. Cl. G06F 3/06; G06F 12/1009

(52) U.S. Cl. CPC G06F 3/0613; G06F 3/0659; G06F 3/0679; G06F 12/1009

(57) ABSTRACT

A storage apparatus includes a controller and a memory device coupled with the controller; the controller is configured to: receive at least one write request, wherein logical address included in the at least one write request is continuous, and the at least one write request indicates that a total amount of data to be written exceeds a first data amount threshold; and write data corresponding to the at least one write request into the memory device continuously in response to the at least one write request.

### CROSS-REFERENCE TO RELATED APPLICATIONS

The present disclosure claims priority to Chinese Patent Application No. 2025104500781, which was filed Apr.10, 2025, and is hereby incorporated herein by reference in its entirety.

### TECHNICAL FIELD

The present disclosure relates to the field of data storage technologies, and in particular, to a storage apparatus, an operation method of a storage apparatus, and an electronic system.

### BACKGROUND

With the development of storage technologies, the amount of data stored in a storage apparatus is increasing.

In the related technologies, in order to ensure the reliability of the storage apparatus, a logical to physical (L2P) mapping table between the logical address (LBA) and the physical address of the data needs to be maintained. For example, after a certain amount of data is written into the storage apparatus, the L2P mapping table is updated.

However, how to improve data writing performance is an urgent problem to be solved.

### SUMMARY

The present disclosure provides a storage apparatus, an operation method of a storage apparatus and an electronic system. The technical solution is as follows:

According to an aspect of the present disclosure, there is provided a storage apparatus comprising a controller and a memory device. The controller is coupled with the memory device. The controller is configured to: receive at least one write request, and write data corresponding to the at least one write request into the memory device continuously in response to the at least one write request. A logical address included in the at least one write request is continuous, and the at least one write request indicates that a total amount of data to be written exceeds a first data amount threshold.

According to another aspect of the present disclosure, there is provided an operation method of a storage apparatus comprising: receiving at least one write request, and writing data corresponding to the at least one write request into a memory device continuously in response to the at least one write request. A logical address included in the at least one write request is continuous, and the at least one write request indicates that a total amount of data to be written exceeds a first data amount threshold.

According to another aspect of the present disclosure, there is provided an electronic system comprising a storage apparatus and a host. The storage apparatus is coupled with the host. The host is configured to send at least one write request to the storage apparatus. A logical address included in the at least one write request is continuous, and the at least one write request indicates that a total amount of data to be written exceeds a first data amount threshold. The storage apparatus is configured to: receive at least one write request; and write data corresponding to the at least one write request into a memory device continuously in response to the at least one write request.

According to another aspect of the present disclosure, there is provided a computer apparatus comprising a processor and a memory, the memory stores at least one instruction, at least one program, a code set, or an instruction set, and the at least one instruction, the at least one program, the code set, or the instruction set is loaded and executed by the processor to implement the operation method of the storage apparatus according to the foregoing aspects.

According to another aspect of the present disclosure, there is provided a computer-readable storage medium storing at least one instruction, at least one program, a code set, or an instruction set, and the at least one instruction, the at least one program, the code set, or the instruction set is loaded and executed by a processor to implement the operation method of the storage apparatus according to the foregoing aspects.

According to another aspect of the present disclosure, there is provided a computer program product comprising computer instructions stored in a computer-readable storage medium, and a processor reads and executes the computer instructions from the computer-readable storage medium to implement the operation method of the storage apparatus according to the foregoing aspects.

### BRIEF DESCRIPTION OF THE DRAWINGS

In order to more clearly illustrate the technical solutions in the examples of the present disclosure, the accompanying drawings that need to be used in the exemplary description are briefly described below, and obviously, the drawings in the following description are merely some examples of the present disclosure, and other drawings may be obtained by those skilled in the art based on these drawings without paying creative efforts.

FIG. 1 is a schematic diagram of an electronic system provided according to an example of the present disclosure.

FIG. 2 is a block diagram of an electronic device having a storage apparatus provided according to an example of the present disclosure.

FIG. 3 is a schematic circuit diagram of a memory device provided according to an example of the present disclosure.

FIG. 4 is a flowchart of an operation method of a storage apparatus provided according to an example of the present disclosure.

FIG. 5 is a flowchart of an operation method of a storage apparatus provided according to an example of the present disclosure.

FIG. 6 is a flowchart of an operation method of a storage apparatus provided according to an example of the present disclosure.

FIG. 7 is a flowchart of an operation method of a storage apparatus provided according to an example of the present disclosure.

FIG. 8 is a schematic diagram of a memory device provided according to an example of the present disclosure.

FIG. 9 is a flowchart of an operation method of a storage apparatus provided according to an example of the present disclosure.

FIG. 10 is a flowchart of an operation method of a storage apparatus provided according to an example of the present disclosure.

FIG. 11 is a flowchart of an operation method of a storage apparatus provided according to an example of the present disclosure.

FIG. 12 is a flowchart of an operation method of a storage apparatus provided according to an example of the present disclosure.

FIG. 13 is a schematic diagram of a memory card provided according to an example of the present disclosure.

FIG. 14 is a schematic diagram of a solid state drive provided according to an example of the present disclosure.

The drawings herein are incorporated in and constitute a part of this specification and illustrate examples consistent with the present disclosure and together with the description serve to explain the principles of the present disclosure.

### DETAILED DESCRIPTION

To make the objectives, technical solutions and advantages of the present disclosure clearer, the implementations of the present disclosure are described in detail below with reference to the accompanying drawings.

Examples will be described in detail herein, examples of which are illustrated in the accompanying drawings. The following description relates to the accompanying drawings, in which like numerals indicate like or similar elements unless otherwise indicated. The implementations described in the following examples do not represent all implementations consistent with the present disclosure. Rather, they are merely examples of devices and methods consistent with some aspects of the present disclosure as detailed in the appended claims.

The terminology used in this disclosure is for the purpose of describing particular examples only and is not intended to limit the present disclosure. As used in this disclosure and the appended claims, the singular forms “a,” “the,” and “said” are also intended to include plural forms, unless the context clearly indicates otherwise. It should also be understood that the terms “and/or” as used herein refer to and include any or all possible combinations of one or more associated listed items.

It should be noted that the user information (including but not limited to user device information, user personal information, etc.) and data (including but not limited to data for analysis, stored data, displayed data, etc.) involved in the present disclosure are information and data that are authorized by the user or are sufficiently authorized by the parties, and collection, use and processing of the related data needs to comply with relevant laws and regulations and standards of related countries and areas.

Although the terms first, second, and the like may be employed in the present disclosure to describe various information, such information should not be limited to these terms. These terms are used only to distinguish the same type of information from one another. For example, the first parameter may also be referred to as a second parameter, similarly, the second parameter may also be referred to as a first parameter without departing from the scope of the present disclosure. The term “if” as used herein may be interpreted as “when” or “in case that” or “in response to a determination” depending on the context.

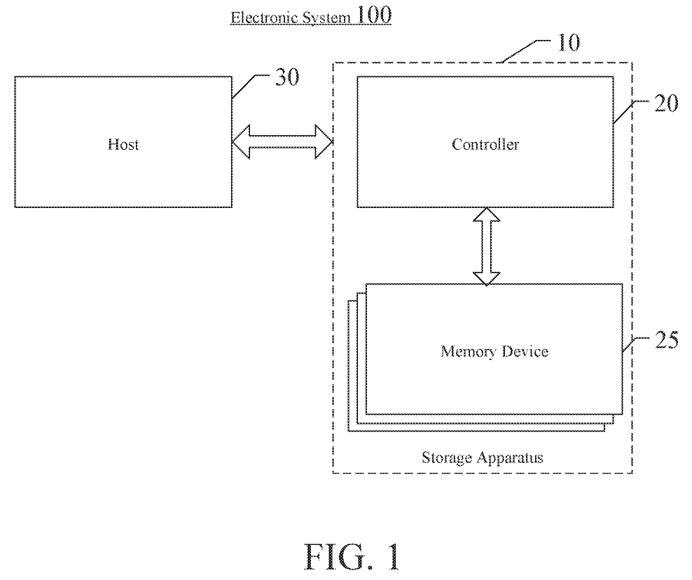

FIG. 1 is a schematic diagram of an electronic system provided according to an example of the present disclosure. As shown in FIG. 1, the electronic system 100 includes one or more memory devices 25, and a controller 20 coupled to the memory device 25 and configured to control the memory device 25. The controller 20 may also be referred to as a memory controller. For example, the storage apparatus 10 includes one or more memory devices 25 and a controller 20.

The controller 20 may be configured to control operations performed by the memory device 25. For example, read, erase, and program operations. The controller 20 may also be configured to manage various functions regarding data stored in or to be stored in the memory device 25, including but not limited to bad block management, garbage collection, logical-to-physical address translation, wear leveling, etc. In an example, the controller 20 may be further configured to process an Error Correcting Code (ECC) regarding data read from or written to the memory device 25. The controller 20 may also perform any other suitable functions. For example, formatting the memory device 25.

The controller 20 may further communicate with an external device according to a particular communication protocol. For example, the controller 20 may communicate with an external device through at least one of various interface protocols. The interface protocol may be a Universal Serial Bus (USB) protocol, a Multi-Media Card (MMC) protocol, a Peripheral Component Interconnect (PCI) protocol, a PCI Express (PCI-E) protocol, an Advanced Technology Attachment (ATA) protocol, a serial ATA protocol, a parallel ATA protocol, a Small Computer System Interface (SCSI) protocol, an Enhanced Small Drive Interface (ESDI) protocol, an Integrated Development Environment (IDE) protocol, a Fire wire protocol, and the like.

In an example, the controller 20 and the one or more memory devices 25 may be integrated into various types of electronic devices. The electronic device may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having memories therein. In this scenario, as shown in FIG. 1, the electronic system 100 further includes a host 30. The controller 20 is coupled to the host 30. The controller 20 may manage data stored in the memory device 25 and communicate with the host 30, to implement the functions of the foregoing electronic device.

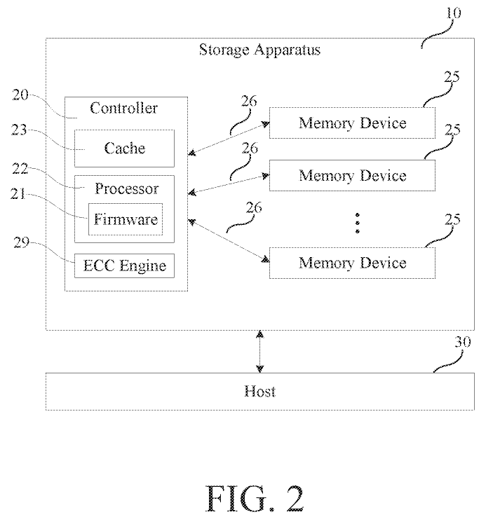

Please refer to FIG. 2, which is a block diagram of an electronic device having a storage apparatus provided according to an example of the present disclosure. For example, the electronic system introduced in FIG. 1 is implemented as an electronic device. In some examples, the electronic device may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having storage apparatuses therein. The storage apparatus 10 may include a controller 20 and one or more semiconductor memory devices 25. Each semiconductor memory device 25 (hereinafter referred to as “memory”) may be a flash memory (e.g., a NAND (Not AND) flash memory, a NOR (Not OR) flash memory, or the like). The storage apparatus 10 may be in communication with a host 30 through a controller 20, which may be connected to one or more memory devices 25 via one or more channels 26. In some examples, each memory device 25 may be managed by the controller 20 via one or more channels 26.

In some examples, the host 30 may include a processor (for example, a central processing unit (CPU), or a system on chip (SoC), for example, an application processor (AP)) of the electronic device. The host 30 may send data to be stored in the storage apparatus 10 and/or may retrieve data from the storage apparatus 10.

In some examples, the controller 20 may process I/O (Input/Output) requests received from the host 30, ensure data integrity and efficient storage, and manage the memory device 25. Next, the controller 20 is described in detail.

To perform tasks such as receiving I/O (Input/Output) requests from the host 30, ensuring data integrity and efficient storage, and managing the memory device 25, the controller 20 may execute firmware 21, which may be executed by one or more processors 22 (e.g., microcontroller unit, CPU) of the controller 20. For example, controller 20 may run firmware 21 to map a logical address (e.g., an address identified by a host associated with host data) to a physical address (e.g., an actual location of stored data) in memory device 25. The controller 20 also runs the firmware 21 to manage defective memory blocks in the memory device 25, where the firmware 21 may remap the logical addresses to different physical addresses, e.g., move the data to different physical addresses.

The controller 20 further includes a cache 23, where the cache 23 is configured to cache data, logical to physical mapping tables (L2P mapping tables), and the like. The cache 23 may be a Random Access Memory (RAM), such as a Static Random Access Memory (SRAM), a Dynamic Random Access Memory (DRAM), or the like.

In some examples, the controller 20 may also perform error recovery by an error correction code (ECC) engine 29. The ECC engine 29 is configured to detect and correct raw bit errors occurring within each memory device 25.

In some examples, the channels 26 may provide data and control communication between the controller 20 and each memory device 25 through a data bus. The controller 20 may select a memory device 25 according to the chip enable signal.

Next, a memory device in a storage apparatus is introduced.

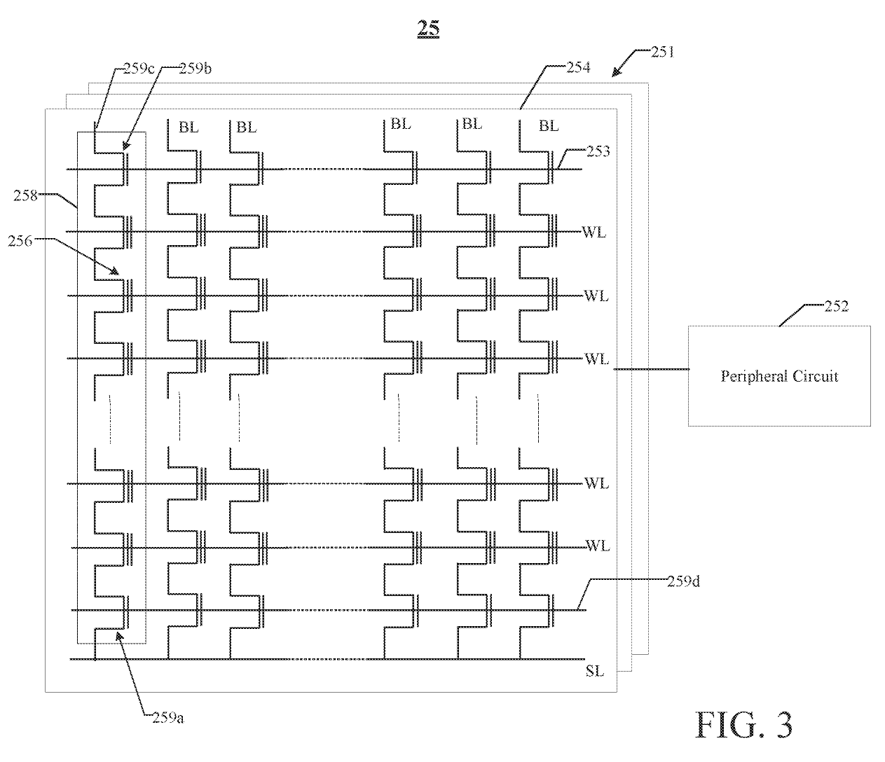

FIG. 3 is a schematic circuit diagram of a memory device provided according to an example of the present disclosure. As shown in FIG. 3, the memory device 25 may include a memory cell array device 251 and a peripheral circuit 252 coupled to the memory cell array device 251. The memory cell array device 251 may be a memory cell array of a NAND flash, where a memory cell 256 is provided in the form of an array of memory strings 258, each extending vertically above a substrate (not shown). In some implementations, each memory string 258 includes a plurality of memory cells 256 coupled in series and stacked vertically. Each memory cell 256 may be a floating gate type memory cell including a floating gate transistor, or a charge trapping type memory cell including a charge trapping transistor. In some implementations, each memory cell 256 is a single-level cell (SLC) having two possible memory states and may store one bit of data. For example, the first memory state “0” may correspond to a first voltage range and the second memory state “1” may correspond to a second voltage range. In some implementations, each memory cell 256 is a multi-level cell capable of storing more than a single bit of data in more than two memory states. For example, two bits (e.g., multi-level cell (MLC)) may be stored per cell, three bits may be stored per cell (e.g., triple-level cell (TLC)), or four bits may be stored per cell (e.g., Quad-Level Cell (QLC)).

As shown in FIG. 3, each memory string 258 may include at least one source select transistor 259a at its source terminal and at least one drain select transistor 259b at its drain terminal. The source select transistor 259a and the drain select transistor 259b may be configured to activate the selected NAND memory string 258 during read and program operations. In some implementations, the sources of the memory strings 258 in the same block 254 are coupled through a same source line (SL). According to some implementations, the drain select transistor 259b of each memory string 258 is coupled to a respective bit line 259c. In some implementations, each memory string 258 is configured to be selected or deselected by applying a select voltage or deselect voltage (e.g., 0V) to the respective drain select transistor 259b via one or more drain select lines (DSL) 253 and/or by applying a select voltage or deselect voltage (e.g., 0V) to the respective source select transistor 259a via one or more source select lines 259d.

As shown in FIG. 3, a memory cell array may include a plurality of blocks. In some implementations, each block 254 is a basic data unit for an erase operation, e.g., all memory cells 256 on the same block 254 are erased simultaneously.

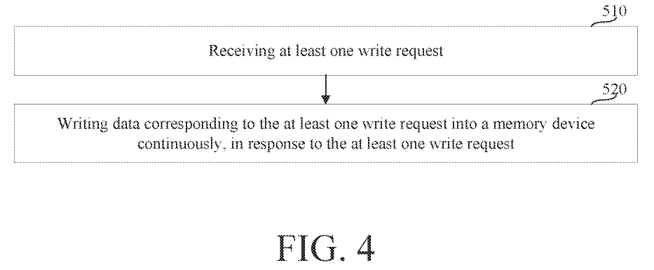

FIG. 4 illustrates a flowchart of a method of operating a storage apparatus provided in an example of the present disclosure. The method may be performed by a storage apparatus. The method includes:

Operation 510: receiving at least one write request.

For example, a logical address included in the at least one write request is continuous, the logical address included in each request of the at least one write request is configured to indicate a start address for writing to the memory device, and the logical address being continuous indicates that a logical address included in one write request is continuous with an end logical address of an adjacent previous request. For example, a logical address included in the at least one write request being continuous may also be referred to as each of the at least one write request indicating to write data in a sequential mode in the memory device.

For example, the logical address may be directly carried in the write request, or may be determined to be continuous by the storage apparatus based on information such as a field carried in the write request. There are no restrictions on the way of determining the continuity of logical address in the present disclosure.

The at least one write request indicates that a total amount of data to be written exceeds a first data amount threshold; and the data amount to be written indicated by any one of the at least one write request is not limited in the present disclosure.

For example, the write request may carry data that needs to be written in the memory device, and the write request may also be implemented as indication information sent to the storage apparatus for indicating that there is data to be written. For example, the at least one write request includes, but is not limited to, being sent by the host to the storage apparatus.

Operation 520: writing data corresponding to the at least one write request into a memory device continuously in response to the at least one write request.

The storage apparatus includes a controller and a memory device, the controller is coupled with the memory device, and the memory device provides a data storage space for storage of the data. The storage apparatus writes data corresponding to the at least one write request into the memory device continuously in response to the at least one write request.

As introduced above, the memory writing the data in the case that the logical address included in the at least one write request is continuous according to the indication of the at least one write request is also referred to as writing the data in a sequential mode or as a sequential write mode. A logical address included in one write request being continuous indicates that a start logical address of data indicated by the one write request is an adjacent address after an end logical address of data indicated by a historical write request adjacent to the write request.

It should be noted that, as introduced in this example, continuously writing data corresponding to the at least one write request into the memory device indicates that the process of writing into the storage apparatus is continuous in the writing process of the data corresponding to each of the at least one write request.

Taking one write request as an example, the data indicated by the write request that needs to be written into the memory has a certain volume. For example, the volume is a plurality of bytes (Byte) to megabytes (MB), and therefore, writing the data to the memory needs a continuous time period. Continuously writing data to the memory device indicates that the time period for the data being written into the memory indicated by one write request is a continuous time period. However, such case is not excluded: after one write request is completed but the next write request is not received, other instructions (such as data read and the like) other than the data write are processed.

In an implementation, a data write duration corresponding to each write request of the at least one write request is less than or equal to a reference write duration of a reference write request corresponding to each write request.

For example, when there are multiple write requests indicating that data is written in the sequential mode in the memory device, for example, when the number of the at least one write request is multiple, each write request has a corresponding data write duration.

Herein, for one write request, the data write duration is a duration from a receipt time of the write request to completion of writing data indicated by the write request. The reference write duration is a duration of a reference time period from a receipt time of the reference write request to completion of writing data indicated by the reference write request. The controller is occupied by other instructions except the reference write request in a portion of the time of the reference time period.

As introduced above, the data indicated by the write request that needs to be written into the memory has a certain volume, and the amount of data indicated by the write request and the amount of data indicated by the reference write request corresponding to the write request to be written are the same; and the influence of the volume of the data on the data write time can be avoided. The reason of the data write duration being less than the reference write duration is that, for the reference write request, the controller is occupied by other instructions except the reference write request. Further, the data indicated by the write request and the data indicated by the reference write request corresponding to the write request to be written are the same data.

In conclusion, according to the method provided in this example, by continuously writing data into the memory device under the condition that the logical address included in the at least one write request is continuous, the problem of low writing performance of the storage apparatus due to interruption of the process of writing data is avoided; and the data amount of writing data to the memory device in unit time under the condition of continuous logical address is improved, and the data writing performance is improved.

In an example design of the present disclosure, in the write time period of each write request of the at least one write request, the processing duration of updating the address mapping table is null; the processing duration of updating the address mapping table being null indicates that in a time period in which the data indicated by the write request is written into the memory, there is no time for performing the address mapping table update, and is also referred to as the processing duration of updating the address mapping table being 0. This avoids updating the address mapping table, which would cause the problem of interrupting data writing to the storage apparatus.

It should be noted that the address mapping table described in each example in the present disclosure may be implemented as a L2P (Logical to Physical) mapping table between a logical address and a physical address, and is not repeated one by one in various examples. Further, the storage location of the address mapping table in the present disclosure is not limited, for example, the address mapping table may be implemented as being stored in any one of a controller or a memory device.

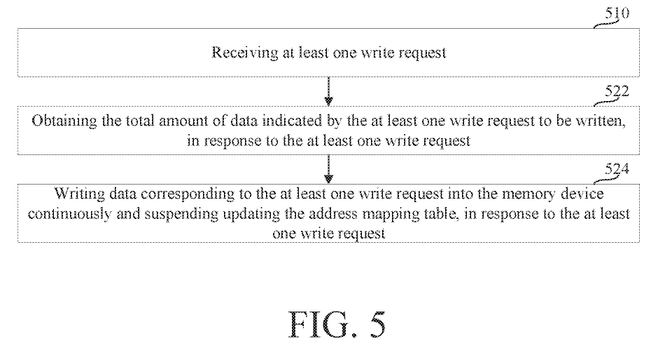

Further, referring to FIG. 5, FIG. 5 illustrates a flowchart of a method of operating a storage apparatus provided in an example of the present disclosure. The method may be performed by a storage apparatus. For example, based on the example shown in FIG. 4, the method further includes operation 522, and further, operation 520 may be implemented as operation 524.

Operation 522: obtaining the total amount of data indicated by the at least one write request to be written, in response to the at least one write request.

For example, the total amount of data indicated by the at least one write request to be written is obtained by counting the amount of data indicated by each of the at least one write request to be written. In an implementation, the write request indicates to write the shard data of the same data volume, and the total amount of data is obtained by counting a product of the number of write requests and a data volume of the shard data.

In an implementation, the total amount of data includes an amount of data indicated by the at least one write request to be written, and the total amount of data further includes a historical data amount. The historical data amount is an amount of data of the historical data, and the historical data is an amount of data written in a case where a logical address included in a historical write request received before the at least one write request is continuous. For example, the historical data amount is the data amount of the historical data to be written in the sequential mode indicated by the historical write request received before the at least one write request.

For example, the mapping relationship between the logical address and the physical address of the historical data in the address mapping table is null. The address mapping table is configured to record a mapping relationship between a logical address and a physical address of data written into the memory device. Since the mapping relationship between the logical address and the physical address of the historical data is not recorded in the address mapping table, the writing process of the historical data is not interrupted by executing the updating address mapping table. The historical data is continuously written into the memory device, and therefore the total amount of data includes the historical data amount.

Operation 524: writing data corresponding to the at least one write request into the memory device continuously and suspending updating the address mapping table in response to the at least one write request.

For example, the at least one write request indicates that the total amount of data to be written exceeds the first data amount threshold. The first data amount threshold is a preset fixed value, for example, 100MB; or may be a value set according to a human-computer interaction operation; or may be implemented as being determined according to a data writing capability of the storage apparatus, for example, a positive correlation relationship exhibits between the first data amount threshold and the data writing speed of the storage apparatus.

For example, the address mapping table is updated by the storage apparatus; in an example, the controller indicates to suspend updating the address mapping table, and the firmware run by the controller indicates to suspend updating the address mapping table. For example, the status bit associated with updating the address mapping table in the firmware run by the controller is changed to achieve suspension of updating the address mapping table.

In this example, suspending updating the address mapping table may be implemented as being in a persistent state. For example, as described above, when there are multiple write requests, there may be a time interval between receiving multiple write requests. When the logical address included in the received write request is continuous, the address mapping table update is kept suspended.

For example, when the logical address included in the write request is continuous, both the logical address and the physical address of the data are sequentially increased with the order of the written data, and the relative relationship between the logical address and the physical address remains unchanged, for example, the numerical difference between the logical address and the physical address (for example, the block number and the page number of the memory device) does not change. Even if the address mapping table update is suspended, the mapping relationship between the logical address and the physical address of each piece of data can be indicated according to the relative relationship between the logical address and the physical address of one piece of data and the total amount of data. Therefore, suspending updating the address mapping table does not cause confusion of allocation of logical addresses.

It should be noted that operation 524 in this example may be combined with operation 510 in the foregoing example into a new example to be implemented separately, which is not limited in the present disclosure.

In conclusion, in the method provided in this example, when the total amount of data exceeds the first data amount threshold, data corresponding to at least one write request with continuous logical address is continuously written into the memory device. Compared with the prior art, after the write data reaches the first data amount threshold, the scheme of updating the address mapping table is triggered. The problem of low writing performance of the storage apparatus due to the interruption during the data writing process is avoided, and meanwhile, frequent adjustment on the updating strategy of the address mapping table is avoided. On the basis of considering the configuration complexity of the storage apparatus, the data amount written to the memory device in unit time under the condition of continuous logical address is improved, and the data writing performance is improved.

Next, the update of the address mapping table is described.

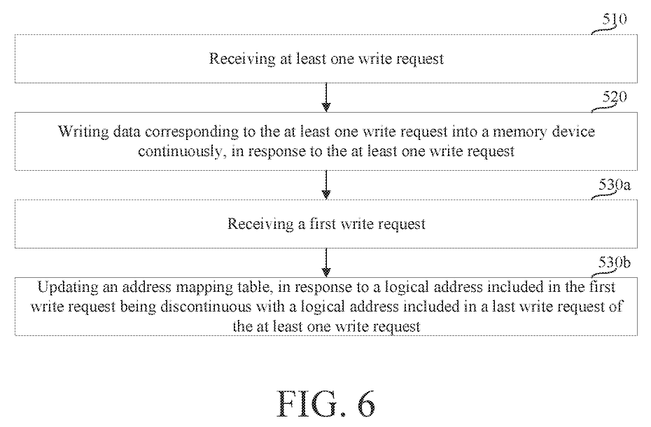

FIG. 6 illustrates a flowchart of a method of operating a storage apparatus provided in an example of the present disclosure. The method may be performed by a storage apparatus. For example, based on the example shown in FIG. 4, operation 530a and operation 530b are further included.

Operation 530a: receiving a first write request.

For example, the address mapping table is configured to record a mapping relationship between a logical address and a physical address of data written into the memory device. The address mapping table is also referred to as a logical to physical (L2P) mapping table to support dynamic translation between logical addresses and physical storage locations (physical addresses). For example, because the storage space provided by the memory device, such as flash memory, cannot be overwritten and needs to be erased first, the storage apparatus needs to write new data to an idle address, and update the address mapping table to indicate where to write the data. For example, the storage apparatus implements dynamic allocation of logical addresses through an address mapping table, avoiding directly overwriting old data.

In this example, the first write request is received after the at least one write request, and the first write request does not belong to the at least one write request.

Operation 530b: updating an address mapping table in response to a logical address included in the first write request being discontinuous with a logical address included in a last write request of the at least one write request.

For example, the logical address included in the first write request is configured to indicate a start address for writing to the memory device. The logical address included in the first write request being discontinuous with the logical address included in the last write request of the at least one write request indicates that the logical address included in the first write request is discontinuous with the end logical address of the adjacent previous request, for example, the logical address included in the first write request is non-adjacent or the logical address is interrupted.

Writing data in a case where the logical address included in the first write request is discontinuous is also referred to as writing in a random mode or as a random write mode.

For example, in response to the logical address included in the first write request being discontinuous with the logical address included in the last write request of the at least one write request, the manner of writing data into the memory device is switched from the write sequential mode to the random mode.

For example, updating the address mapping table may be updating the mapping relationship between the logical address and the physical address of the data corresponding to the at least one write request in operation 510 and operation 520 described above; or may be updating the first write request and the mapping relationship between the logical address and the physical address of the data indicated to be written in a case where the logical address included in the write request is discontinuous after the first write request.

In an implementation of the present disclosure, operation 530b may be implemented as the following two sub-operations:

Sub-operation 1: constructing, in response to the first write request, mapping information of data corresponding to the at least one write request based on a start logical address and a start physical address of a first data and the total amount of data.

For example, in this example, after receiving the first write request, the mapping information of the data indicated by at least one write request with a continuous logical address to be written into the memory device (also referred to as the data written into the memory device in the sequential mode) is updated.

Similar to the at least one write request described above, the indication manner of writing data in a random mode is not limited in the present disclosure. How the write request indicates to write data in the random mode or the sequential mode will be described below in a separate example.

For example, the first data is the data indicated by a first write request of the at least one write request to be written; the mapping information is constructed based on a start logical address, a start physical address, and a total amount of data, and the total amount of data is a total amount of data indicated by the at least one write request to be written.

For example, the mapping information is implemented as a key-value pair and a key and a value in the key-value pair are determined based on the start logical address and the start physical address, and the total amount of data is the remark information of the key-value pair. For example, the mapping information directly records a mapping relationship between a logical address and a physical address of the data indicated by the first write request to be written. For example, the mapping relationship between the logical address and the physical address of the data written into the memory device in the sequential mode may be indirectly indicated according to the mapping information according to the start logical address, the start physical address in the key-value pair and the total amount of data.

Sub-operation 2: updating the address mapping table with the mapping information.

For example, the mapping information is added to the address mapping table to update the address mapping table.

In an implementation, this operation may be implemented as: updating the mapping information in the address mapping table through a background task in response to the storage apparatus being in an idle state.

In the case where the storage apparatus is in the idle state, the energy consumption of the storage apparatus is reduced. For example, the storage apparatus turns off part of the circuit or reduces the operation frequency, but still keeps the basic function ready. The mapping information is added in the address mapping table through a background task, so that the interruption of the data writing and data reading tasks being executed, or the influence on the rate of data writing and data reading, caused by the data writing, the data processing and the like that are needed when the mapping information is added, can be avoided.

In conclusion, according to the method provided in this example, by continuously writing data into the memory device under the condition that the logical address included in the at least one write request is continuous, the problem of low writing performance of the storage apparatus due to interruption of the process of writing data is avoided; and the data amount of writing data to the memory device in unit time under the condition of continuous logical address is improved, and the data writing performance is improved. By constructing the mapping information based on the start logical address, the start physical address and the total amount of data, the data size of the address mapping table is reduced, the complexity of searching the mapping relationship between the logical address and the physical address in the address mapping table is reduced in the data reading process of the storage apparatus, and the reading performance of the storage apparatus is improved, compared with the technical scheme of recording the mapping relationship between the logical address and the physical address of each piece of data in the related technologies.

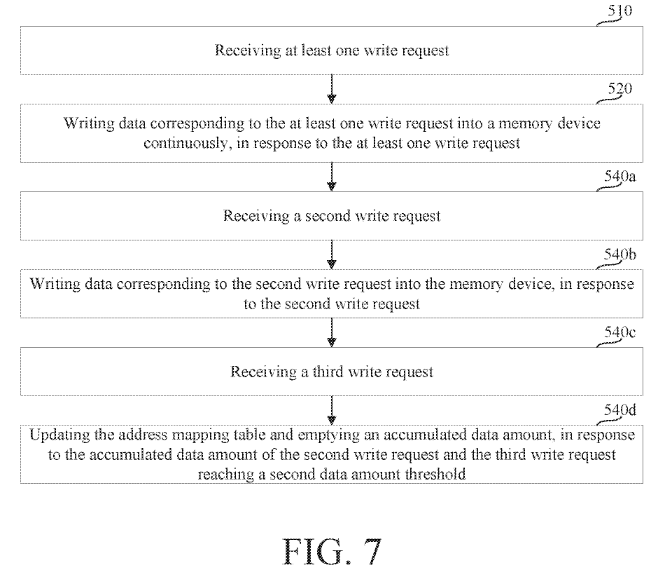

FIG. 7 illustrates a flowchart of a method of operating a storage apparatus provided in an example of the present disclosure. The method may be performed by a storage apparatus. For example, based on the example shown in FIG. 4, operation 540a to operation 540d are further included.

Operation 540a: receiving a second write request.

In this example, the second write request is received after the at least one write request. In some examples, the second write request does not belong to the at least one write request.

In this example, a relationship between the second write request and the foregoing first write request is not limited, and does not exclude a case in which the second write request and the foregoing first write request are the same write request.

Operation 540b: writing data corresponding to the second write request into the memory device in response to the second write request.

For example, the second write request is configured to indicate to write data in the memory device. The controller writes the data corresponding to the second write request into the memory device based on the second write request.

Operation 540c: receiving a third write request.

In this example, the logical address included in the third write request is discontinuous with the logical address included in the second write request; and the third write request is received after the second write request.

For example, the logical address included in the third write request is configured to indicate a start address for writing to the memory device. The logical address included in the third write request being discontinuous with the logical address included in the second write request indicates that the logical address included in the third write request is discontinuous with the end logical address of the adjacent second write request, for example, the logical address included in the third write request is non-adjacent or the logical address is interrupted.

Operation 540d: in response to an accumulated data amount of the second write request and the third write request reaching a second data amount threshold, updating the address mapping table and emptying the accumulated data amount.

For example, the accumulated data amount is an amount of at least one piece of data written to the memory device in the case that the logical address included in the write request is discontinuous. In an implementation, the random mode writes the shard data of the same data volume, and the accumulated data amount is obtained by counting a product of the number of the shard data written to a memory device in the random mode and a data volume of the shard data.

For the data written to the memory device in the case that the logical address included in the write request is discontinuous, the address mapping table is updated when the counted accumulated data amount reaches the second data amount threshold. The mapping relationship between the logical address and the physical address of the data written to the memory device in the random mode is updated in the address mapping table, for example, the mapping relationship between the data indicated by the second write request to be written and the data indicated by the third write request to be written is updated.

For example, by emptying the accumulated data amount, updating the address mapping table in a manner of taking reaching the second data amount threshold as a period is achieved. For example, a value of the second data amount threshold and a value of the first data amount threshold described in operation 510 may be the same or different. Further, the second data amount threshold is less than the first data amount threshold.

Further, in response to receiving a write request including a logical address that is not continuous after emptying the accumulated data amount, operations 540a to 540d are repeatedly performed, so that updating the address mapping table in a manner of taking reaching the second data amount threshold as a period is achieved.

It should be noted that operation 530a and operation 530b in FIG. 6, and operation 540a to operation 540d in FIG. 7, and operation 510 and operation 530 may be combined into a new example to be performed separately. This is not limited in the present disclosure.

In conclusion, according to the method provided in this example, by continuously writing data into the memory device under the condition that the logical address included in the at least one write request is continuous, the problem of low writing performance of the storage apparatus in the sequential writing mode due to interruption of the process of writing data is avoided; and the data amount of writing data to the memory device in unit time under the condition of continuous logical address is improved, and the data writing performance is improved. By updating the address mapping table in response to the logical address included in the first write request being discontinuous with the logical address included in the last write request of the at least one write request, it is ensured that the mapping relationship between the logical address and the physical address of the data indicated by the at least one write request, in which the logical address is continuous, to be written is recorded in the address mapping table, thereby avoiding a problem of logical address allocation disorder in a subsequent read/write process of the storage apparatus.

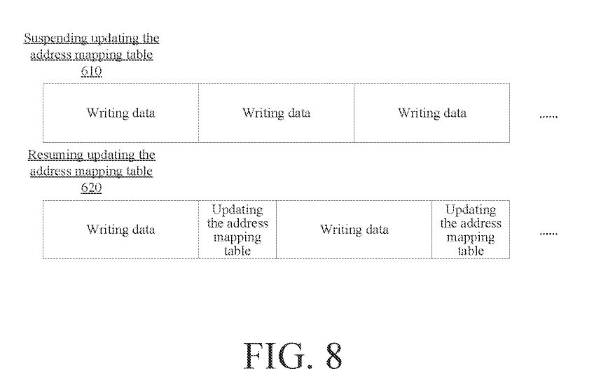

FIG. 8 illustrates a schematic diagram of a memory device provided according to an example of the present disclosure. As described above, in a case where the data is continuously written in sequential mode to the memory device in response to at least one write request, updating the address mapping table 610 is suspended. In the case where updating the address mapping table 610 is suspended, over time, there is no time period for updating the address mapping table, and the data indicated by the host is continuously written into the memory device.

In the case where updating address mapping table 620 is resumed, when the data written to the memory device reaches the first data amount threshold, the address mapping table is updated; and writing the data into the memory device is interrupted by updating the address mapping table. It can be seen from FIG. 8 that, due to the influence of updating the address mapping table, writing of two pieces of data can be completed under the condition that updating address mapping table 620 is resumed based on the same consumption time; and writing of three pieces of data can be completed under the condition that updating address mapping table 610 is suspended. The method of operating the storage apparatus provided in the present disclosure has higher data writing efficiency for the data written into the memory device in the sequential mode, compared with the condition of updating the address mapping table.

For example, the condition of resuming updating the address mapping table 620 described in FIG. 8 may be configured to display a data writing process after the sequential mode is switched to the random mode; or may also be configured to display a process of keeping updating the address mapping table when writing data in the sequential mode in the related technology.

Next, the logical address included in the write request being continuous is introduced.

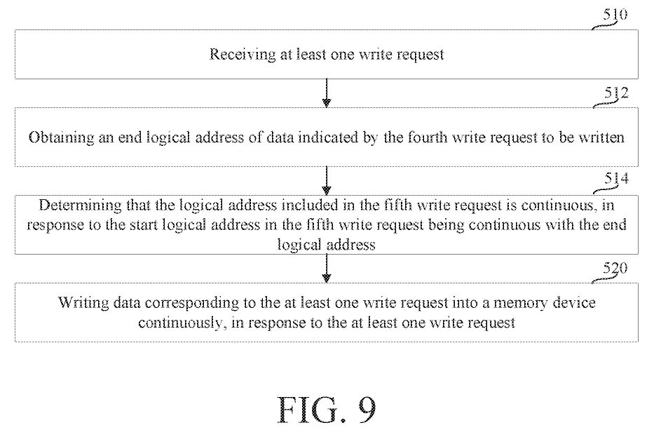

In an example, the logical address included in the write request being continuous is implemented as indicating, by the start logical address of the carried data, that the logical address is continuous. Correspondingly, FIG. 9 illustrates a flowchart of a method of operating a storage apparatus provided in an example of the present disclosure. The method may be performed by a storage apparatus. For example, based on the example shown in FIG. 4, operation 512 and operation 514 are further included.

Operation 512: obtaining an end logical address of data indicated by the fourth write request to be written.

In this example, the fourth write request is a write request received before the fifth write request and adjacent to the fifth write request. The end logical address is the last logical address that is occupied when writing the data indicated by the fourth write request to be written to the memory device is completed. For example, the end logical address is an address of the last logical block occupied when writing the data indicated by the fourth write request to the memory device is completed.

Operation 514: in response to the start logical address in the fifth write request being continuous with the end logical address, determining that the logical address included in the fifth write request is continuous.

In a case where the start logical address in the fifth write request is continuous with the end logical address (for example, the start logical address in the fifth write request is the adjacent address after the end logical address), the logical address included in the fifth write request is continuous relative to the fourth write request that is adjacent in front, for example, the fifth write request indicates to write the data to the memory device in a sequential manner.

In this example, the logical address included in the fifth write request being continuous is implemented as indicating, by the start logical address of the data carried in the fifth write request, that the logical address is continuous.

It should be noted that, in this example, the number of the at least one write request is implemented as multiple, and the at least one write request includes a fourth write request and a fifth write request. As described above, the fourth write request and the fifth write request are two adjacent write requests included in the at least one write request.

In an implementation, if the fifth write request is the first request of the at least one write request, or the number of the at least one write request is implemented as one, the start logical address in the fifth write request is continuous with the end logical address are. The end logical address is the last logical address occupied when the write request received before the fifth write request and adjacent to the fifth write request completes writing; it may be understood that the foregoing adjacent write request does not belong to the at least one write request. Because the start logical address in the fifth write request is continuous with the end logical address, the logical address included in the fifth write request is continuous, and the fifth write request belongs to at least one write request.

In another implementation, the fifth write request may be other requests besides the first request of the at least one write request; and in a case where the fifth write request may be the second write request of the at least one write request that is sequentially arranged in an order by acquisition time from first to last, the logical address included in the fifth write request is determined to be continuous in response to the start logical address in the fifth write request being continuous with the end logical address. Herein, the end logical address is the last logical address that is occupied when the first write request of the at least one write request that is sequentially arranged in an order by acquisition time from first to last completes writing. It may be understood that, over time, the number of the at least one write request may be implemented as more write requests of other locations in the at least one write request that is sequentially arranged in an order by acquisition time from first to last, reference is made to the description above of the second write request of the at least one write request that is sequentially arranged in an order by acquisition time from first to last, and so on.

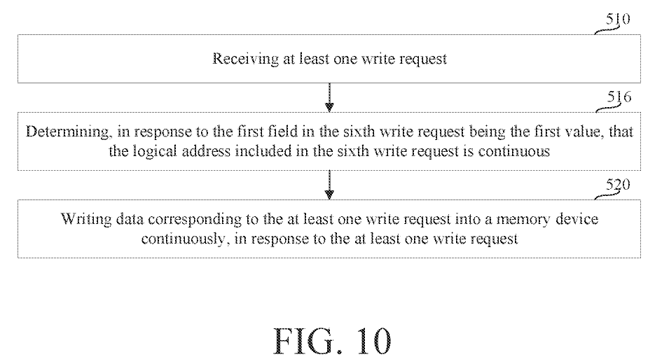

In another example, the logical address included in the write request being continuous is implemented to indicate that the logical address is continuous by using a value in one field in the write request. Correspondingly, FIG. 10 illustrates a flowchart of a method of operating a storage apparatus provided in an example of the present disclosure. The method may be performed by a storage apparatus. For example, based on the example shown in FIG. 4, operation 516 is further included.

Operation 516: determining, in response to the first field in the sixth write request being the first value, that the logical address included in the sixth write request is continuous.

For example, the sixth write request is any one of at least one write request; and for example, the first field in the sixth write request is configured to indicate a data write mode of the sixth write request, for instance, the data write mode is the sequential mode or the random mode described above. The first value is configured to indicate that the data writing mode is writing data in a manner of continuous logical address, for example, the data writing mode is a sequential mode. The first field carrying the first value indicates that the logical address is continuous, and then the data is written in the sequential mode.

For example, the first field is configured to indicate that the data writing mode is a sequential mode or a random mode, the first value is configured to indicate that the data writing mode is a sequential mode, which may be negotiated and determined in advance by the host and the storage apparatus, or may be preset in a communication protocol such that the host and the storage apparatus send information according to a same communication protocol.

It should be noted that the foregoing two implementations introduces a manner of determining that logical addresses included in the third write request and the sixth write request are continuous, but does not exclude a case in which at least one write request in operation 510 includes more or less number of write requests. In the present disclosure, operation 512, operation 514, operation 516, and operation 510 to operation 520 described above may be combined into a new example to be implemented separately. Operations 512 and 514 may also be performed repeatedly, and operation 516 may be performed repeatedly to determine that a greater number of write requests indicate writing data in sequential mode. The foregoing execution manners are not limited in the present disclosure.

In conclusion, according to the method provided in this example, by continuously writing data into the memory device under the condition that the logical address included in the at least one write request is continuous, the problem of low writing performance of the storage apparatus due to interruption of the process of writing data is avoided; and the data amount of writing data to the memory device in unit time under the condition of continuous logical address is improved, and the data writing performance is improved.

In an example of the present disclosure, there is provided a storage apparatus including a memory device; and a controller coupled to the memory device and configured to:

- receive a first write request.

In this example, the introduction of the first write request to the third write request is not applicable to the first to sixth write requests in the method of operating the storage apparatus in the foregoing example unless separately illustrated.

The first write request is configured to indicate to write data in the memory device. The controller writes the data corresponding to the first write request into the memory device based on the first write request.

- Write data corresponding to the first write request to the memory device in response to the first write request.

The first write request is configured to indicate to write data in the memory device. The controller writes the data corresponding to the first write request into the memory device based on the first write request.

- Receive a second write request, where a logical address included in the second write request is continuous with a logical address included in the first write request, and a total amount of data included in the second write request and the first write request exceeds a first data amount threshold.

For example, a logical address included in the second write request is continuous with a logical address included in the first write request.

- Write data corresponding to the second write request into the memory device continuously in response to the second write request.

For example, the second write request and the first write request write data in the memory device in a manner of continuous logical address. Writing the data corresponding to the second write request to the memory device continuously indicates that, in the writing process of the data corresponding to the second write request, the process of writing into the storage apparatus is continuous.

In an alternative design, the controller is further configured to: suspend updating an address mapping table.

Herein, the address mapping table is configured to record a mapping relationship between a logical address and a physical address of data written into the memory device.

For example, the address mapping table is updated by the storage apparatus; in an example, the controller indicates to suspend updating the address mapping table, and the firmware run by the controller indicates to suspend updating the address mapping table. For example, the status bit associated with updating the address mapping table in the firmware run by the controller is changed to suspend updating the address mapping table.

In an alternative design, the controller is further configured to: receive a third write request; and update an address mapping table in response to a logical address included in the third write request being discontinuous with a logical address included in the second write request.

For example, the third write request is received after the second write request. For example, the logical address included in the third write request is configured to indicate a start address for writing to the memory device. The logical address included in the third write request being discontinuous with the logical address included in the second write request indicates that the logical address included in the third write request is discontinuous with the end logical address of the second write request, for example, the logical address included in the third write request is non-adjacent or the logical address is interrupted.

For further description of the update manner of the address mapping table and suspending updating the address mapping table, please refer to the example corresponding to the foregoing method of operating of the storage apparatus. It may be understood that the storage apparatus described in this example may have a corresponding method of operating of the storage apparatus, and correspondingly, the method includes: receiving a first write request; writing data corresponding to the first write request to the memory device in response to the first write request; receiving a second write request, where a logical address included in the second write request is continuous with a logical address included in the first write request, and a total amount of data included in the second write request and the first write request exceeds a first data amount threshold; and writing data corresponding to the second write request into the memory device continuously in response to the second write request.

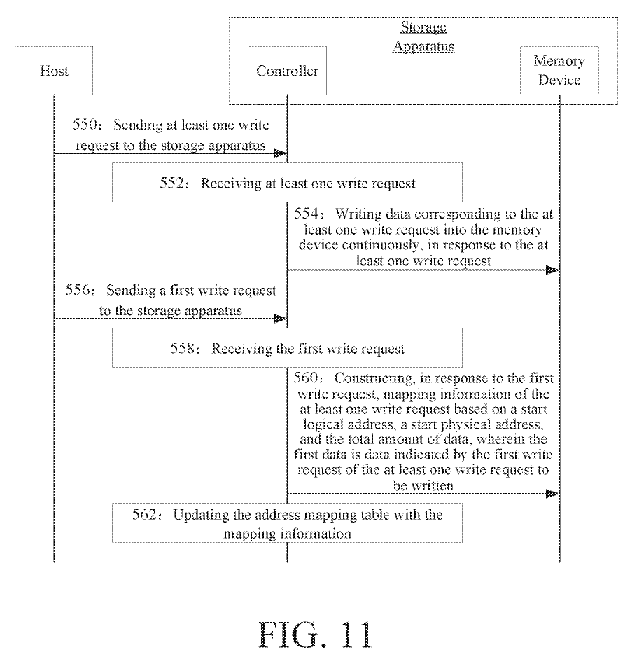

FIG. 11 illustrates a flowchart of a method of operating of a storage apparatus provided in an example of the present disclosure. The method may be performed by an electronic system including a storage apparatus and a host, the storage apparatus is coupled with the host, and the method includes:

Operation 550: sending, by the host, at least one write request to the storage apparatus.

For example, the logical address included in each request of the at least one write request is configured to indicate a start address for writing to the memory device, and the logical address being continuous indicates that a logical address included in one write request is continuous with an end logical address of an adjacent previous request. The total amount of data indicated by the at least one write request to be written exceeds the first data amount threshold.

Operation 552: receiving, by the storage apparatus, at least one write request.

The storage apparatus includes a controller and a memory device, the controller is coupled with the memory device, and the memory device provides a data storage space for storage of the data. For example, the controller in the storage apparatus receives the at least one write request.

Operation 554: writing, by the storage apparatus, data corresponding to the at least one write request into a memory device continuously in response to the at least one write request.

The memory writes data to the memory device in accordance with the indication of the at least one write request. Writing data in a case where the logical address included in the at least one write request is continuous may also be referred to as writing data in a sequential mode or as a sequential writing mode.

For example, the controller in the storage apparatus writes data corresponding to the at least one write request into the memory device continuously in response to the at least one write request.

In an implementation, a data write duration corresponding to each write request of the at least one write request is less than or equal to a reference write duration of a reference write request corresponding to each write request.

For example, when there are multiple write requests indicating that data is written in the sequential mode in the memory device, for example, when the number of the at least one write request is multiple, each write request has a corresponding data write duration.

It should be noted that for further introduction of the at least one write request, the storage apparatus, and the reference write duration, reference may be made to the foregoing examples, and details are not described herein again.

Operation 556: sending, by the host, a first write request to the storage apparatus.

For example, a logical address included in the first write request is discontinuous, the logical address included in the first write request is configured to indicate a start address for writing to the memory device, and the logical address being discontinuous indicates that a logical address included in the first write request is non-adjacent to an end logical address of an adjacent previous request. The mode of writing data in the memory device is switched from the sequential mode to the random mode because the logical address included in the first write request is discontinuous with the logical address included in the last write request of the at least one write request.

Operation 558: receiving, by the storage apparatus, the first write request.

For example, the controller in the storage apparatus receives the first write request.

Operation 560: constructing, by the storage apparatus and in response to the first write request, mapping information of the at least one write request based on a start logical address, a start physical address, and the total amount of data, where the first data is data indicated by the first write request of the at least one write request to be written.

For example, the first data is the data indicated by a first write request of the at least one write request to be written; the mapping information is constructed based on a start logical address, a start physical address, and a total amount of data, and the total amount of data is a total amount of data indicated by the at least one write request to be written.

Operation 562: updating, by the storage apparatus, the address mapping table with the mapping information.

For example, the mapping information is added to the address mapping table to update the address mapping table.

In an implementation, this operation may be implemented as: adding the mapping information to the address mapping table through a background task in response to the storage apparatus being in an idle state.

It may be understood that, operation 558 to operation 562 described above are configured to indicate the storage apparatus to update an address mapping table in response to a logical address included in the first write request being discontinuous with a logical address included in a last write request of the at least one write request.

Herein, the address mapping table is configured to record a mapping relationship between a logical address and a physical address of data written into the memory device.

In conclusion, according to the method provided in this example, by continuously writing data into the memory device in a sequential writing mode, the problem of low writing performance of the storage apparatus in the sequential writing mode due to interruption of the process of writing data is avoided; and the data amount of writing data to the memory device in unit time in the sequential mode is improved, and the data writing performance in the sequential mode is improved.

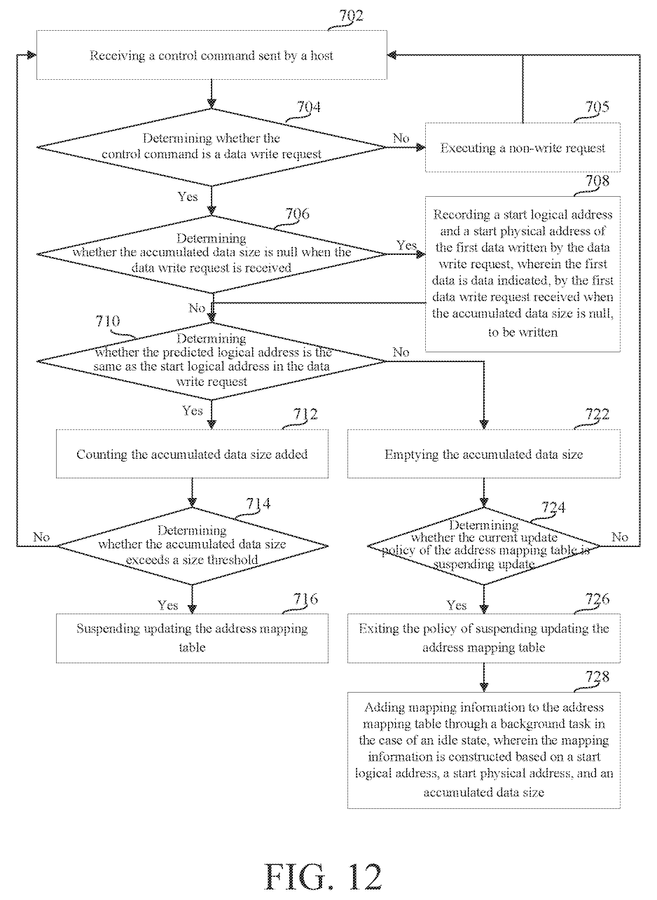

FIG. 12 illustrates a flowchart of a method of operating a storage apparatus provided in an example of the present disclosure. The method may be performed by a storage apparatus. The method includes:

Operation 702: receiving a control command sent by a host.

For example, the storage apparatus receives a control command sent by the host, where the control instruction that the host has the sending capability may be at least one of instructions for indicating to write data, read data, edit data, set an operation state of the storage apparatus, and other attribute information in the storage apparatus.

Operation 704: determining whether the control command is a data write request.

Determining whether the control command is a data write request according to the type of the received control command. If the control command is a data write request, operation 706 is performed; if the control command is not a data write request, operation 705 is performed.

Operation 705: executing a non-write request.

For example, operation 705 is performed if the control command is not a data write request. The control command is a non-write request. After receiving a non-write request, the storage apparatus performs the non-write request.

For example, after performing the non-write request, the storage apparatus performs operation 702 to receive a new control command sent by the host.

Operation 706: determining whether the accumulated data size is null when the data write request is received.

For example, operation 706 is performed if the control command is a data write request. The control command in operation 702 is a data write request.

Whether the accumulated data size is null when the data write request is received is determined by querying the accumulated data size. In some examples, the accumulated data size is null is configured to indicate that the value of the field indicated by the accumulated data size is 0, or there is no field indicated by the accumulated data size.

If the accumulated data size is null when the data write request is received, operation 708 is performed; and if the accumulated data size is not null when the data write request is received, operation 710 is performed.

Operation 708: recording a start logical address and a start physical address of the first data written by the data write request, where the first data is data indicated, by the first data write request received when the accumulated data size is null, to be written.

For example, operation 708 is performed when the accumulated data size is null when the data write request is received. A basis is provided for updating the address mapping table by recording a start logical address and a start physical address of the first data.

For example, after performing operation 708, the storage apparatus continues to perform operation 710.

Operation 710: determining whether the predicted logical address is the same as the start logical address in the data write request.

For example, operation 710 is performed if the accumulated data size is not null when the data write request is received or is performed after operation 708.

Whether the data write mode executed by the data write request is the sequential mode or the random mode is determined by determining whether the predicted logical address is the same as the start logical address in the data write request. Herein, the predicted logical address is a historical write request received before the control command received in operation 702 and adjacent to the control command. The predicted logical address is the adjacent address after the end logical address of the data indicated by the historical write request to be written. For further description of the predicted logical address, please refer to the second write request and the end logical address of the second write request in the example shown in FIG. 9.

If the predicted logical address is the same as the start logical address in the data write request, the data write mode executed by the data write request is the sequential mode, and operation 712 is performed. If the predicted logical address is different from the start logical address in the data write request, the data write mode executed by the data write request is the random mode, and operation 722 is performed.

Operation 712: counting the accumulated data size added.

For example, operation 712 is performed if the predicted logical address is the same as the start logical address in the data write request.

Counting the accumulated data size added is configured to indicate that the size of the data indicated by the data write request to be written to the memory device is added to the accumulated data size. For example, counting the accumulated data size added is performed after the data indicated by the data write request is successfully written into the memory device.

Operation 714: determining whether the accumulated data size exceeds a size threshold.

Determining whether the accumulated data size added in operation 712 exceeds a size threshold. When the accumulated data size does not exceed the size threshold, processing of the data write request is completed, and operation 702 is performed to receive a new control command sent by the host. If the accumulated data size exceeds the size threshold, operation 716 is performed.

Operation 716: suspending updating the address mapping table.

For example, operation 716 is performed if the accumulated data size exceeds the size threshold. By suspending updating the address mapping table, the problem of low writing performance of the storage apparatus in the sequential writing mode due to interruption of the process of writing data is avoided; and the data writing performance of the storage apparatus is improved.

Operation 722: emptying the accumulated data size.

For example, operation 722 is performed if the predicted logical address is not the same as the start logical address in the data write request. The accumulated data size is emptied by setting the value of the field indicated by the accumulated data size to 0, or deleting the field indicated by the accumulated data size. For example, this operation is performed after, before, or at the same time of successfully writing the data indicated by the data write request into the memory device.

Operation 724: determining whether the current update policy of the address mapping table is suspending update.

For example, whether the current update policy of the address mapping table is suspending update is determined by querying the current update policy of the address mapping table.

When the current update policy of the address mapping table is not suspending update, the current update policy of the address mapping table is to keep updating. For example, for the data write request of writing data in the random mode, the address mapping table can be kept updated, so that the problem of chaotic logical address allocation will not occur. Upon completion of processing the data write request, operation 702 is executed to receive a new control command sent by the host. If the current update policy of the address mapping table is suspending update, operation 726 is performed.

Operation 726: exiting the policy of suspending updating the address mapping table;

For example, the policy of suspending updating the address mapping table is exited, and the update policy of the address mapping table is changed to keeping updating to avoid the problem of chaotic logical address allocation.

Operation 728: adding mapping information to the address mapping table through a background task in the case of an idle state, where the mapping information is constructed based on a start logical address, a start physical address, and an accumulated data size.

For example, the start logical address and the start physical address are a start logical address and a start physical address of the data of the first write request obtained in operation 708 that indicate to write data in the sequential mode. The accumulated data size is the size of data written to the memory device in the sequential mode counted after the data write is performed. For example, the mapping information is added to the address mapping table to update the address mapping table.

It should be noted that after operation 728 and operation 716 are performed, operation 702 may be further performed to receive a new control command sent by the host.

In conclusion, according to the method provided in this example, by continuously writing data into the memory device in a sequential writing mode, the problem of low writing performance of the storage apparatus in the sequential writing mode due to interruption of the process of writing data is avoided; and the data amount of writing data to the memory device in unit time in the sequential mode is improved, and the data writing performance in the sequential mode is improved.

Those skilled in the art may understand that the foregoing examples may be implemented independently, or the foregoing examples may be freely combined to form a new example to implement the method of operating of the storage apparatus in the present disclosure.

In an example of the present disclosure, there is provided a storage apparatus including a controller and a memory device, where the controller is coupled with the memory device.

the controller is configured to: receive at least one write request, where a logical address included in the at least one write request is continuous, and a total amount of data indicated by the at least one write request to be written exceeds a first data amount threshold; and write data corresponding to the at least one write request into the memory device continuously in response to the at least one write request.

In an implementation of this example, a data write duration corresponding to each write request of the at least one write request is less than or equal to a reference write duration of a reference write request corresponding to each write request.

In an implementation of this example, in the write time period of each write request, the processing duration of updating the address mapping table is null; where the address mapping table is configured to record a mapping relationship between a logical address and a physical address of data written into the memory device.

In an implementation of this example, the controller is further configured to: obtain the total amount of data indicated by the at least one write request to be written, in response to the at least one write request, where the mapping relationship between the logical address and the physical address of the at least one write request in the address mapping table is null.

In an implementation of this example, the controller is further configured to: write data corresponding to the at least one write request into the memory device continuously and suspend updating the address mapping table in response to the at least one write request.

In an implementation of this example, the controller is further configured to: receive a first write request; and update an address mapping table in response to a logical address included in the first write request being discontinuous with a logical address included in a last write request of the at least one write request, where the logical address included in the first write request is discontinuous, the address mapping table is configured to record a mapping relationship between a logical address and a physical address of data written into the memory device.

In an implementation of this example, the controller is further configured to: construct, in response to the first write request, mapping information of data corresponding to the at least one write request based on a start logical address and a start physical address of a first data and the total amount of data, where the first data is data indicated by a first write request of the at least one write request to be written; and update the address mapping table with the mapping information.

In an implementation of this example, the controller is further configured to: update the mapping information in the address mapping table through a background task in response to the storage apparatus being in an idle state.

In an implementation of this example, the controller is further configured to: receive a second write request; write data corresponding to the second write request into the memory device in response to the second write request; receive a third write request, where a logical address included in the third write request is discontinuous with a logical address included in the second write request; and update the address mapping table and empty the accumulated data amount, in response to the accumulated data amount of the second write request and the third write request reaching a second data amount threshold.

In an example of the present disclosure, there is provided an electronic system including a storage apparatus and a host, where the storage apparatus is coupled with the host; the host is configured to send at least one write request to the storage apparatus, where a logical address included in the at least one write request is continuous, and a total amount of data indicated by the at least one write request to be written exceeds a first data amount threshold; the storage apparatus is configured to receive at least one write request; and write data corresponding to the at least one write request to a memory device continuously in response to the at least one write request.

In an implementation of this example, a data write duration corresponding to each write request of the at least one write request is less than or equal to a reference write duration of a reference write request corresponding to each write request.

In an implementation of this example, the storage apparatus is further configured to: receive a first write request; and update an address mapping table in response to a logical address included in the first write request being discontinuous with a logical address included in a last write request of the at least one write request, where the logical address included in the first write request is discontinuous, the address mapping table is configured to record a mapping relationship between a logical address and a physical address of data written into the memory device.

In an implementation of this example, the host is further configured to send the first write request to the storage apparatus; the storage apparatus is further configured to receive the first write request; construct, in response to the first write request, mapping information of data corresponding to the at least one write request based on a start logical address and a start physical address of a first data and the total amount of data, where the first data is data indicated by a first write request of the at least one write request to be written; and update the address mapping table with the mapping information.

It should be noted that, when at least one of the electronic system and the storage apparatus provided in the foregoing examples implements the function thereof, the foregoing configuration manners are only used for illustration. In actual application, the foregoing functions may be allocated to be completed by different function modules according to actual needs. For example, the content structure of the device is divided into different function modules to complete all or part of the functions described above.

For at least one of the electronic systems and the storage apparatuses in the foregoing examples, the specific manner in which each module performs the operation has been described in detail in the example related to the method; and the technical effect obtained by performing the operation of each module is the same as the technical effect of the example related to the method, and will not be described in detail herein.

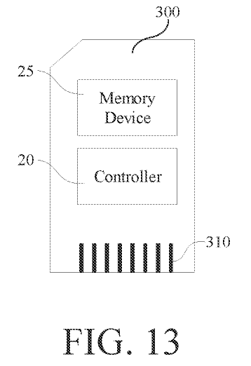

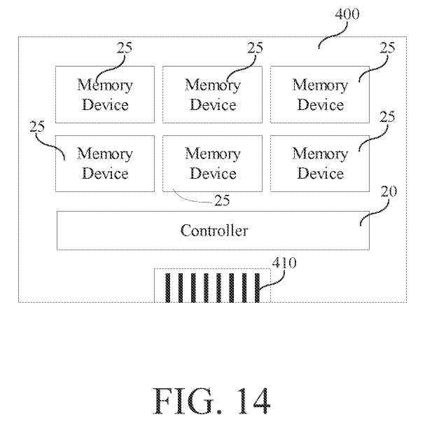

In some examples, the controller 20 and the one or more memory devices 25 are included in the same package, such as a Universal Flash Storage (UFS) package or an eMMC (embedded Multi Media Card) package. For example, the storage apparatus may be implemented and packaged into different types of terminal electronics. In one example as shown in FIG. 13, the controller 20 and a single memory device 25 may be integrated into the memory card 300. The memory card 300 may include a PC (PCMCIA, Personal Computer Memory Card International Association) card, a CF (Compact Flash) card, a Smart Media (SM) card, a memory stick, a multimedia card (MMC, RS-MMC, MMCmicro), an SD card (SD, miniSD, microSD, SDHC), UFS, or the like. The memory card 300 may also include a memory card connector 310 that couples the memory card 300 with a host (e.g., host 30 in FIG. 1). In another example as shown in FIG. 14, the controller 20 and multiple memory devices 25 may be integrated into an SSD 400. The SSD 400 may also include an SSD connector 410 that couples the SSD 400 with a host (e.g., host 30 in FIG. 1).

The storage apparatuses may be one or more of a universal flash memory, an embedded multimedia card, a UFS-based Multichip Package (uMCP) memory, an eMMC-based Multichip Package (eMCP) memory, a solid state drive, and the like, which is not limited in the present disclosure.

In an example, as described in the foregoing electronic system, the storage apparatus is coupled to a host, the host includes a host memory and a host processor, the host memory stores a computer program, and the computer program is loaded and executed by the host processor to implement the method of operating of the foregoing host.

The host processor includes a CPU or a system-on-a-chip (e.g., an application processor), and the host memory may include one or more computer-readable storage media, which may be tangible and non-transitory. The memory may further include a high-speed random access memory, and a non-volatile memory, such as one or more magnetic disk storage apparatuses and a flash storage apparatus.

In some examples, a firmware image is stored in the host memory. In some examples, the non-transitory computer-readable storage medium in the host memory stores a computer program loaded and executed by the processor to implement the method of operating of the foregoing host, thereby downloading the firmware image from the host to the controller.

An example of the present disclosure further provides a computer-readable storage medium, where the computer-readable storage medium stores a computer program, and the computer program is loaded and executed by a processor to implement the method of operating of the foregoing host, or to implement the method of operating of the foregoing controller.

In an example, the computer-readable storage medium may include a ROM, a RAM, a Solid State Disk/Solid State Drive (SSD), an optical disc, or the like. The RAM may include a Resistance Random Access Memory (ReRAM) and a Dynamic Random Access Memory (DRAM) and the like.

An example of the present disclosure further provides a computer program product, where the computer program product includes a computer program, the computer program is stored in a computer-readable storage medium, and the processor reads and executes the computer program from the computer-readable storage medium to implement the method of operating of the foregoing host (in this case, the computer program is stored in the foregoing host memory), or the processor implements the method of operating of the controller (in this case, the computer program is the first firmware stored in the foregoing controller).

A person skilled in the art may understand that all or part of the operations for implementing the foregoing examples may be completed by hardware, or may be completed by a program instructing related hardware, and the program may be stored in a computer-readable storage medium. The foregoing storage medium may be a read-only memory, a magnetic disk, an optical disk, or the like.

Those skilled in the art should appreciate that, in one or more of the above examples, the functions described in the examples of the present disclosure may be implemented in hardware, software, firmware, or any combination thereof. When implemented using software, these functions may be stored in a computer-readable medium or transmitted as one or more instructions or codes on a computer-readable medium. A computer-readable medium includes a computer storage medium and a communication medium, where the communication medium includes any medium that facilitates transmission of a computer program from one place to another. The storage medium may be any available media that can be accessed by a general purpose or special purpose computer.

The above are only examples of the present disclosure and shall not be used to restrict the present disclosure. Any modification, equivalent replacement, improvement, etc., made within the spirits and principles of the present disclosure shall be included in the protection scope of the present disclosure.

What is claimed is:

1. A storage apparatus, comprising:
a memory device, and
a controller coupled with the memory device and configured to:
receive at least one write request, wherein a logical address included in the at least one write request is continuous, and the at least one write request indicates that a total amount of data to be written exceeds a first data amount threshold; and
write data corresponding to the at least one write request into the memory device continuously, in response to the at least one write request.

2. The storage apparatus according to claim 1, wherein a data write duration corresponding to each write request in the at least one write request is less than or equal to a reference write duration of a reference write request corresponding to the each write request.

3. The storage apparatus according to claim 2, wherein a processing duration in a write time period of the each write request for updating an address mapping table is null; and
wherein the address mapping table is configured to record a mapping relationship between a logical address and a physical address of data written into the memory device.

4. The storage apparatus according to claim 3, wherein the controller is further configured to:
obtain the total amount of data to be written indicated by the at least one write request, in response to the at least one write request,
wherein the mapping relationship between the logical address and the physical address of the at least one write request in the address mapping table is null.

5. The storage apparatus according to claim 1, wherein the controller is further configured to:
write data corresponding to the at least one write request into the memory device continuously and suspend updating an address mapping table, in response to the at least one write request.

6. The storage apparatus according to claim 1, wherein the controller is further configured to:
receive a first write request; and
update an address mapping table, in response to the logical address included in the first write request being discontinuous with the logical address included in a last write request of the at least one write request.

7. The storage apparatus according to claim 6, wherein the controller is further configured to:
construct, in response to the first write request, mapping information of data corresponding to the at least one write request based on a start logical address and a start physical address of a first data and the total amount of data, wherein the first data is data to be written indicated by a first write request of the at least one write request; and
update the address mapping table with the mapping information.

8. The storage apparatus according to claim 6, wherein the controller is further configured to:
update mapping information in the address mapping table through a background task, in response to the storage apparatus being in an idle state.

9. The storage apparatus according to claim 1, wherein the controller is further configured to:
receive a second write request;
write data corresponding to the second write request into the memory device, in response to the second write request;
receive a third write request, wherein the logical address included in the third write request is discontinuous with the logical address included in the second write request; and
update the address mapping table, and empty an accumulated data amount, in response to the accumulated data amount of the second write request and the third write request reaching a second data amount threshold.

10. A method of operating a storage apparatus, comprising:
receiving at least one write request, wherein a logical address included in the at least one write request is continuous, and the at least one write request indicates that a total amount of data to be written exceeds a first data amount threshold; and
writing data corresponding to the at least one write request into a memory device continuously, in response to the at least one write request.

11. The method according to claim 10, wherein a data write duration corresponding to each write request in the at least one write request is less than or equal to a reference write duration of a reference write request corresponding to the each write request.

12. The method according to claim 11, wherein a processing duration in a write time period of the each write request for updating an address mapping table is null; and
wherein the address mapping table is configured to record a mapping relationship between a logical address and a physical address of data written into the memory device.

13. The method according to claim 12, further comprising:
obtaining the total amount of data to be written indicated by the at least one write request, in response to the at least one write request,
wherein the mapping relationship between the logical address and the physical address of the at least one write request in the address mapping table is null.

14. The method according to claim 10, wherein writing data corresponding to the at least one write request into the memory device continuously, in response to the at least one write request comprises:
writing data corresponding to the at least one write request into the memory device continuously and suspending updating an address mapping table, in response to the at least one write request.

15. The method according to claim 10, further comprising:
receiving a first write request; and
updating an address mapping table, in response to the logical address included in the first write request being discontinuous with the logical address included in a last write request of the at least one write request.

16. The method according to claim 15, wherein updating an address mapping table in response to a logical address included in the first write request being discontinuous with a logical address included in a last write request of the at least one write request comprises:
constructing, in response to the first write request, mapping information of data corresponding to the at least one write request based on a start logical address and a start physical address of a first data and the total amount of data, wherein the first data is data to be written indicated by a first write request of the at least one write request; and
updating the address mapping table with the mapping information.

17. The method according to claim 16, wherein updating the address mapping table with the mapping information further comprises:
updating the mapping information in the address mapping table through a background task, in response to the storage apparatus being in an idle state.

18. The method according to claim 10, further comprising:
receiving a second write request;
writing data corresponding to the second write request into the memory device, in response to the second write request;
receiving a third write request, wherein a logical address included in the third write request is discontinuous with a logical address included in the second write request; and
in response to an accumulated data amount of the second write request and the third write request reaching a second data amount threshold, updating an address mapping table and emptying the accumulated data amount.

19. A storage apparatus, comprising:
a memory device; and
a controller coupled with the memory device and configured to:
receive a first write request;
write data corresponding to the first write request into the memory device, in response to the first write request;
receive a second write request, wherein a logical address comprised in the second write request is continuous with a logical address comprised in the first write request, and a total amount of data to be written indicated by the second write request and the first write request exceeds a first data amount threshold; and
write data corresponding to the second write request into the memory device continuously, in response to the second write request.

20. The storage apparatus according to claim 19, wherein the controller is further configured to:
suspend updating an address mapping table,
wherein the address mapping table is configured to record a mapping relationship between a logical address and a physical address of data written into the memory device.
